(19) United States
(12) Patent Application Publication
(10) Pub. No.: US 2023/0109747 A1
(43) Pub. Date: Apr. 13, 2023

(54) Training method and system for machine learning assisted determination of product HS-Codes

(71) Applicant: Security Indicator LLC, Riyadh (SA)

(72) Inventor: Adil Mohammad Assiri, Riyadh (SA)

(21) Appl. No.: 17/719,349

(22) Filed: Apr. 12, 2022

Related U.S. Application Data
(63) Continuation-in-part of application No. 17/497,891, filed on Oct. 9, 2021, now abandoned.

(51) Int. Cl. G06N 20/10; G06Q 40/00

(52) U.S. Cl. CPC G06N 20/10; G06Q 40/123

(57) ABSTRACT

The present invention is directed at a system of determining a product's HS-Code based on the product's title. The system may employ ML models to assign the HS-Codes. A first ML model provides a full 6-digit HS-Code. A second ML model also provides the full 6-digit HS-Code, where the ML general model provides the first two digits of the HS-Code and the ML submodels provide the last four digits of the HS-Code. Efficiently and accurately determining a product's HS-Code using machine learning reduces the manual inspection of shipments entering customs, saving time and effort for workers, and improves the detection of prohibited or controlled products.

### CROSS-REFERENCE TO RELATED APPLICATIONS

This application is a Continuation-in-part of U.S. non-provisional application Ser. No. 17/497,891, filed on Oct. 9, 2021, the content of which is incorporated by reference.

### BACKGROUND

### Field of the Invention

The present invention relates generally to training a machine learning model, and, in particular, to training a machine learning model to identify restricted and prohibited goods to reduce manual inspection at customs ports.

### Scope of the Prior Art

Saudi Arabia has recently seen a rapid increase in the daily traffic of cross-border trade and the import of new goods, leading to the emergence of several security issues due to the inefficient and often inaccurate nature of customs procedures. Currently, imported goods are manually inspected at customs ports where experts determine the category of the imported goods, labeling each product with its associated Harmonized System (HS-Code). A product's HS-Code determines which duties and taxes apply. Furthermore, products with suspicious HS-Codes are targeted for examination to ensure that no prohibited shipment enters the country, as well as ensuring that the restricted products fulfil the required approvals before entering the country.

Manually inspecting each imported good to determine its category is prone to human error, resulting in a high rate of products mislabeled with the wrong HS-Code. Furthermore, manual inspection is time consuming and reduces the speed of customs clearance, lowering Saudi Arabia's rank in the trading across borders indicator. Consequently, there is a need for a method of determining a product's HS-Code in a timely, consistent, and reliable manner. Preferably, a product's HS-Code is determined solely from the product's title. Technology such as machine learnings can be leveraged to improve the accuracy of determining a product's HS-Code, which, in turn, improves the accuracy of targeting suspicious goods as well as the accuracy of applying appropriate duties and taxes.

### SUMMARY

The present disclosure satisfies the foregoing needs by providing, inter alia, a ML model training method and system for ML identification of products.

One aspect of the present invention is directed at a computer-implemented method of training a machine learning general model to determine an HS-Code based on the product's title, the method comprising: receiving a set of product titles; applying a term frequency operation and an inverse document frequency operation to each of the product titles to create a set of product terms; manually assigning an HS-Code to each of the product terms to create a set of HS-Codes; creating a training set comprising the set of product terms and the set of HS-Codes; and training the machine learning general model with the training set using supervised learning, wherein the set of product terms is an input and the set of HS-Codes is a desired output. The machine learning general model may be trained using a Support Vector Machine algorithm.

Another aspect of the present invention is directed at system for identifying an HS-Code based on a product title, the system comprising: an input device configured to receive the product title; an output device configured to display the HS-Code, wherein the HS-Code corresponds to the product title; a processor; memory; a machine learning general model stored in the memory and executed in the processor, the model trained by: receiving a set of product titles; applying a term frequency operation and an inverse document frequency operation to each of the product titles to create a set of product terms; manually assigning an HS-Code to each of the product terms to create a set of HS-Codes; creating a training set comprising the set of product terms and the set of HS-Codes; and training the machine learning general model with the training set using supervised learning, wherein the set of product terms is an input and the set of HS-Codes is a desired output.

Another aspect of the present invention is directed at a system for identifying an HS-Code based on a product title, the system comprising: an input configured to receive the product title; an output device configured to display the HS-Code, wherein the HS-Code corresponds to the product title; a processor; memory; a machine learning general model stored in the memory and executed in the processor, the general model trained by: receiving a set of product titles; applying a term frequency operation and an inverse document frequency operation to each of the product titles to create a set of product terms; manually assigning an HS-Code to each of the product terms to create a set of HS-Codes; creating a training set comprising the set of product terms and the set of HS-Codes; training the machine learning general model with the training set using supervised learning, wherein the set of product terms is an input and the set of HS-Codes is a desired output.

The system may further comprise machine learning submodels stored in the memory and executed in the processor, the submodels trained by: receiving a set of the product titles; applying the term frequency operation and the inverse document frequency operation to each of the product titles to create the set of product terms; manually assigning the HS-Code to each of the product terms to create the set of HS-Codes; creating the training set comprising the set of product terms and the set of HS-Codes, the training set divided into a training subset for each chapter number, wherein each training subset contains a subset of product terms and a subset of HS-Codes; training the machine learning submodels with the training subsets using supervised learning, wherein a subset of product terms is an input and a subset of HS-Codes is a desired output.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1 is a simplified block diagram of an HS-Code determination system, according to one embodiment of the present invention.

FIG. 2 is a schematic block diagram of a first machine learning model's training phase, according to one embodiment of the present invention.

FIG. 3 is a flowchart of the steps of a first method of determining the HS-Code of a product, according to one embodiment the present invention.

FIG. 4 is a schematic block diagram of a second machine learning model's training phase, according to one embodiment of the present invention.

FIG. 5 is a flowchart of the steps of a second method of determining the HS-Code of a product, according to one embodiment the present invention.

FIG. 6 depicts an HS-Code split into a first 2-digit chapter number and a second 4-digit remainder.

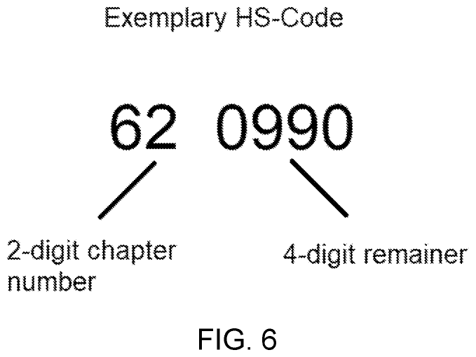

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of a training method and system for machine learning assisted determination of HS-Codes, it will be recognized by those of ordinary skill that the present disclosure is not so limited. In fact, the principles of the present disclosure described herein may be readily applied to the identification and categorization of goods themselves.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

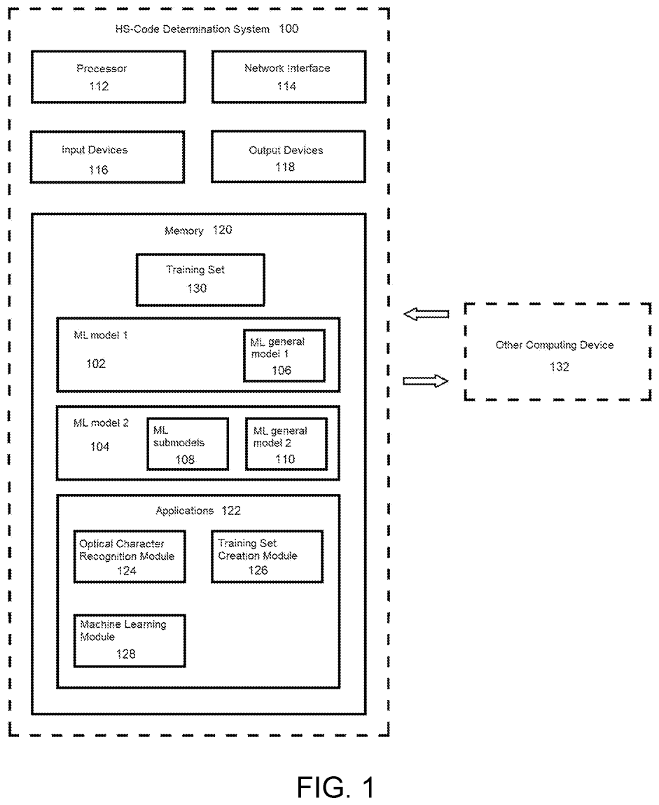

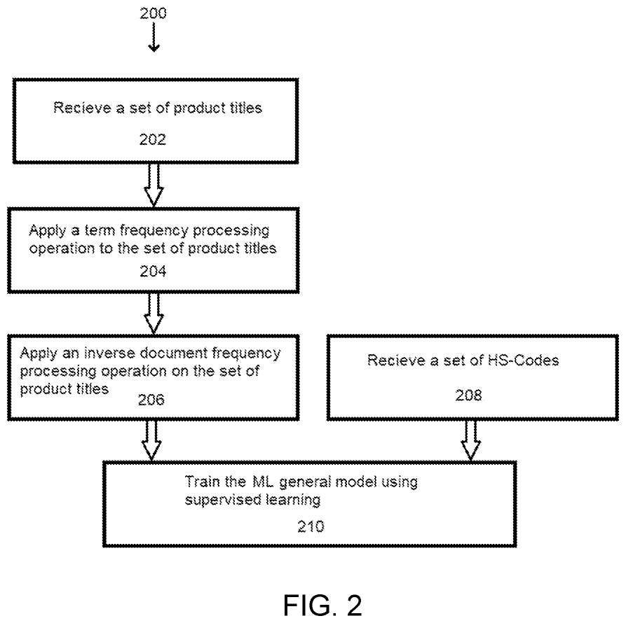

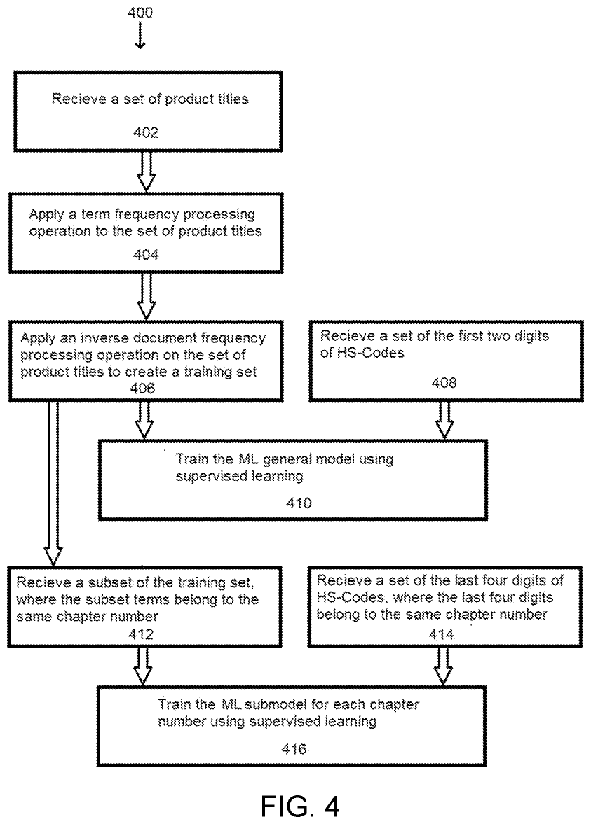

FIG. 1 is simplified block diagram of an HS-Code determination system. The system may determine HS-Codes using ML model 1 (102) produced by the training method of FIG. 2 or ML model 2 (104) produced by the training method of FIG. 4. ML model 1 (102) is comprised of ML general model 1 (106) as will be later described. ML model 2 (104) is comprised of ML general model 2 (108) and ML submodels (110) as will be later described. Embodiments of the invention may be implemented via local and remote computing and data storage systems.

In an embodiment, the HS-Code determination system 100 may include at least one processor 112 to execute computer readable program instructions in order to carry out aspects of the present invention and a network interface 114 for network enablement. System 100 may further include input devices 116 configured to accept user inputs, including product titles, and output devices 118 configured to output system data, including HS-Codes.

HS-Code determination system 100 may further include memory 120 in the form of any type of short and long-term computer readable storage medium known in the art. Computer readable storage medium can be a tangible device that can retain and store instructions for use by an instruction execution device such as the processor. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Memory 120 may be loaded with various applications 122 in the form of computer readable program instructions. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Applications 122 in the form of computer readable program instructions may include an optical recognition module 124 to scan product titles. Applications may further include a training set creation module 126 to create a training set for the ML model. The training set creation module 126 may be configured to perform term frequency and inverse document frequency operations on a set input product titles. Applications 122 may further include a machine learning module 128 to create ML models. The machine leashing module 128 may be configured to perform ML modeling operations on the training set, including, but not limited to, Support Vector Machine, Random Forest, Naïve Bayes, and Multi-Linear Regression operations. Accordingly, memory includes all necessary modules per each embodiment.

Memory may further include training set data 130 including, but not limited to, a term frequency—inverse document frequency set of product titles and a corresponding list of full 6-digits HS-Codes as will be later discussed. The ML general models may produce, based on the product title, a 6-digit HS Code or the first two digit chapter number as will be later discussed. The ML submodels may produce a 4-digit remainder based on the product title and the first 2-digit chapter number as will be later discussed.

Any suitable combination of hardware, software, or firmware may be used to implement memory and processor functions. For example, memory and processor functions may be implemented using a combination of computing devices in a distributed computing environment. In FIG. 1, HS-Code determination system 100 may assign a portion, or all, of memory and processing functions to any number of other computing devices 132. Other computing devices 132 may have equivalent hardware, software, or firmware to perform the functionality of the HS-Code determination system 100. Alternatively, other computing devices 132 may have the hardware, software, or firmware to solely perform certain functions, for example, memory for data storage.

FIG. 2 is a schematic block diagram of a first ML model's training method 200. The first ML model is comprised of a ML general model.

Training starts at block 202. A set of product titles is received. According to an embodiment, the set of product titles is inputted into the HS-Code determination system. For example, a user inputs a set of product titles such as

$$\begin{matrix}Product\_titles = \\ \\ \\ \end{matrix} \begin{matrix}[ flat screen television flat screen display ] \\ nutritional cat food cat \\ apple flavored all natural candies \\ hamburger food ]\end{matrix}$$

Training proceeds to block 204. A term frequency processing operation is applied to the set of product titles, creating a term frequency set of product titles that contain the relative frequency of the term within the product title. For example, the system applies the term frequency text preprocessing technique to the product_titles set, creating the term frequency set of product titles such as

$$\begin{matrix}tf\_product \_titles = \\ \\ \\ \end{matrix} \begin{matrix}[ flat : 2 , screen : 2 , television : 1 , display : 1 \\ cat : 2 , food : 1 , nutritional : 1 \\ apple : 1 , flavored : 1 , all : 1 , natural : 1 , candies : 1 \\ hamburger : 1 , food , 1 ]\end{matrix}$$

Training proceeds to block 206. An inverse document frequency text processing operation is applied to the term frequency set of product titles, creating a term frequency—inverse document frequency set of product titles, that contain a measure of how much information a term has multiplied by the term frequency. For example, the system applies the inverse document frequency text preprocessing technique to the tf_product_titles set, creating the term frequency—inverse document frequency set of product titles such as

$$\begin{matrix}tf\_idf \_product \_titles = \\ \\ \\ \\ \\ \\ \\ \\ \\ \\ \\ \\ \end{matrix} \begin{matrix}[ flat : 0.201 , 0 , 0 , 0 \\ screen : 0.201 , 0 , 0 , 0 \\ television : 0.1 , 0 , 0 , 0 \\ display : 0.1 , 0 , 0 , 0 \\ nutritional : 0 , 0.151 , 0 , 0 \\ cat : 0 , 0.151 , 0.05 , 0 \\ food : 0 , 0.075 , 0 , 0.151 \\ apple : 0 , 0 , 0.1 , 0 \\ flavored : 0 , 0 , 0.1 , 0 \\ natural : 0 , 0 , 0.1 , 0 \\ \text{"candies} : 0, 0, 0.1, 0 \\ hamburger : 0 , 0 , 0. \text{.301} ]\end{matrix}$$

This term frequency—inverse document frequency set of product titles is the training set for the ML general model. Blocks 200, 202, and 204 comprise stage 1 of the ML model's training method.

Training proceeds to block 208. A set of 6-digit HS-Codes is received. Each 6-digit HS-Code corresponds to a product title. The 6-digit HS-Codes may be assigned by a team of custom clearance experts.

Training proceeds to block 210. The ML general model is trained to accurately identify the 6-digit HS-Code based on a product's title. The ML general model uses supervised learning where the training set is the input and the set of correct 6-digit HS-Codes is the output.

| Example input: | | Example output: | |
|---|---|---|---|
| tf_idf_product_titles = | [“flat”: 0.201, 0, 0, 0 | HS_Code= | [123456 |
| | “screen”: 0.201, 0, 0, 0 | | 123456 |
| | “television”: 0.1, 0, 0, 0 | | 123456 |
| | “display”: 0.1, 0, 0, 0 | | 123456 |
| | “nutritional”: 0, 0.151, 0, 0 | | 234567 |
| | “cat”: 0, 0.151, 0.05, 0 | | 234567 |
| | “food”: 0, 0.075, 0, 0.151 | | 456789 |
| | “apple”: 0, 0, 0.1, 0 | | 345678 |
| | “flavored”: 0, 0, 0.1, 0 | | 345678 |
| | “natural”: 0, 0, 0.1, 0 | | 345678 |
| | “candies: 0, 0, 0.1, 0 | | 345678 |
| | “hamburger”: 0, 0, 0, 0.301] | | 456789] |

In a preferred embodiment, the ML general model uses the Support Vector Machine algorithm to convert text data into mathematical matrices by increasing the number of dimensions to separate each word in each product title. The algorithm relies on temporarily creating dummy data in mathematical matrices for the purpose of create a gap between each HS-Code determination. In alternative embodiments, the ML general model uses random forest, naïve bayes, or multi-linear regression algorithms. Block 210 comprises stage 2 of the ML general model's training phase. The final output of stage 2 is a ML general model that outputs a 6-digit HS-Code for each product, based on the terms in the product's title.

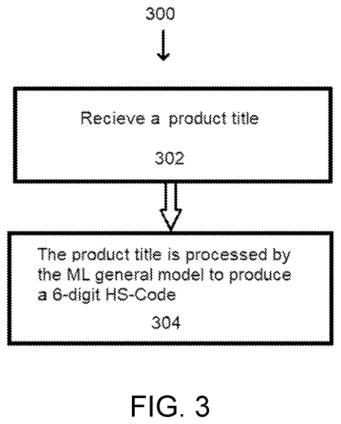

FIG. 3 is flowchart of the steps of a first method 300 of determining the HS-Code of a product, according to one embodiment the present invention.

The method starts at block 302. A user inputs a product title into the HS-code determination system where the ML general model of the system has been trained according to the training method of FIG. 2.

The method ends at block 304. The product title is processed by the ML model, where the ML model outputs the 6-digit HS-Code based the product title. This 6-Digit HS-Code can be entered into the custom's database to determine appropriate product taxes and whether or not the product poses a security risk.

FIG. 4 is a schematic block diagram of a second ML model's training method 400. The second ML model is comprised of a general ML model and its associated ML submodels.

Training starts at block 402. A set of product titles is received. According to an embodiment, the set of product titles is inputted into the HS-Code determination system. For example, a user inputs a set of product titles such as

$$\begin{matrix}Product\_titles = \\ \\ \\ \end{matrix} \begin{matrix}[ flat screen television flat screen display ] \\ nutritional cat food cat \\ apple flavored all natural candies \\ hamburger food ]\end{matrix}$$

Training proceeds to block 404. A term processing operation is applied to the set of product titles, creating a term frequency set of product titles that contain the relative frequency of the term within the product title. For example, the system applies the term frequency text preprocessing technique to the product_titles set, creating the term frequency set of product titles such as

$$\begin{matrix}tf\_product \_titles = \\ \\ \\ \end{matrix} \begin{matrix}[ flat : 2 , screen : 2 , television : 1 , display : 1 \\ cat : 2 , food : 1 , nutritional : 1 \\ apple : 1 , flavored : 1 , all : 1 , natural : 1 , candies : 1 \\ hamburger : 1 , food , 1 ]\end{matrix}$$

Training proceeds to block 406. An inverse document frequency text processing operation is applied to the term frequency set of product titles, creating a term frequency—inverse document frequency set of product titles, that contain a measure of how much information a term has multiplied by the term frequency. For example, the system applies the inverse document frequency text preprocessing technique to the tf_product_titles set, creating the term frequency—inverse document frequency set of product titles such as

$$\begin{matrix}tf\_idf \_product \_titles = \\ \\ \\ \\ \\ \\ \\ \\ \\ \\ \\ \\ \end{matrix} \begin{matrix}[ flat : 0.201 , 0 , 0 , 0 \\ screen : 0.201 , 0 , 0 , 0 \\ television : 0.1 , 0 , 0 , 0 \\ display : 0.1 , 0 , 0 , 0 \\ nutritional : 0 , 0.151 , 0 , 0 \\ cat : 0 , 0.151 , 0.05 , 0 \\ food : 0 , 0.075 , 0 , 0.151 \\ apple : 0 , 0 , 0.1 , 0 \\ flavored : 0 , 0 , 0.1 , 0 \\ natural : 0 , 0 , 0.1 , 0 \\ \text{"candies} : 0, 0, 0.1, 0 \\ hamburger : 0 , 0 , 0. \text{.301} ]\end{matrix}$$

This term frequency—inverse document frequency set of product titles is the training set for the ML general model. Blocks 400, 402, and 404 comprise stage 1 of the ML model's training phase.

Training proceeds to block 408. A set of the first two digits of HS-Codes is received. Each two-digit HS-Code corresponds to a product title. The two-digit HS-Codes may be assigned by a team of custom clearance experts.

Training proceeds to block 410. The ML general model is trained to accurately identify the first two digits (the chapter number) of the 6-digit HS-Code. The ML general model uses supervised learning where the training set is the input and the set of the first two digits of the correct 6-digit HS-Codes is the output.

| Example input: | | Example output: | |
|---|---|---|---|
| tf_idf_product_titles = | [“flat”: 0.201, 0, 0, 0 | 2_digit_HS_Code= | [12 |
| | “screen”: 0.201, 0, 0, 0 | | 12 |
| | “television”: 0.1, 0, 0, 0 | | 12 |
| | “display”: 0.1, 0, 0, 0 | | 12 |
| | “nutritional”: 0, 0.151, 0, 0 | | 23 |
| | “cat”: 0, 0.151, 0.05, 0 | | 23 |
| | “food”: 0, 0.075, 0, 0.151 | | 45 |
| | “apple”: 0, 0, 0.1, 0 | | 34 |
| | “flavored”: 0, 0, 0.1, 0 | | 34 |
| | “natural”: 0, 0, 0.1, 0 | | 34 |
| | “candies: 0, 0, 0.1, 0 | | 34 |
| | “hamburger”: 0, 0, 0, 0.301] | | 45] |

In a preferred embodiment, the ML general model uses the Support Vector Machine algorithm to convert text data into mathematical matrices by increasing the number of dimensions to separate each word in each product title. The algorithm relies on temporarily creating dummy data in mathematical matrices for the purpose of create a gap between each HS-Code determination. In alternative embodiments, the ML general model uses random forest, naïve bayes, or multi-linear regression algorithms.

Training proceeds to block 412. A subset of the training set is received. The subset terms may all correspond to the same chapter number.

Training proceeds to block 414. A set of the last four digits of HS-Codes is received. Each four-digit HS-Code corresponds to a term in the training subset. The four-digit HS-Codes may all correspond to the same chapter number. The four-digit HS-Codes may be assigned by a team of custom clearance experts.

Training proceeds to block 416. For each chapter number, a ML submodel is trained to accurately identify the last four digits (the remainder) of the 6-digit HS-Code. The ML submodels use supervised learning where the training set associated with a chapter number is the input and the set of the last four digits of the correct 6-digit HS-Codes is the output. The 6-digit HS-Codes may be assigned by a team of custom clearance experts.

| Example input: | | Example output: | |
|---|---|---|---|
| tf_idf_product_titles = | [“flat”: 0.201, 0, 0, 0 | 4_digit_HS_Code = | [3456 |
| | “screen”: 0.201, 0, 0, 0 | | 3456 |
| | “television”: 0.1, 0, 0, 0 | | 3456 |
| | “display”: 0.1, 0, 0, 0 | | 3456] |

In a preferred embodiment, the ML submodels use the Support Vector Machine algorithm to convert text data into mathematical matrices by increasing the number of dimensions to separate each word in each product title. The algorithm relies on temporarily creating dummy data in mathematical matrices for the purpose of create a gap between each HS-Code determination. In alternative embodiments, the ML submodels use random forest, naïve bayes, or multi-linear regression algorithms. Blocks 410 and 416 comprise stage 2 of the ML model's training phase. The final output of stage 2 is a ML general model that outputs the first two digits of the HS-Code for each product, based on the terms in the product's title and ML submodels that output the last 4 digits of the HS-Code for each product, based on the product's title and the first two digits of the HS-Code provided by the general model.

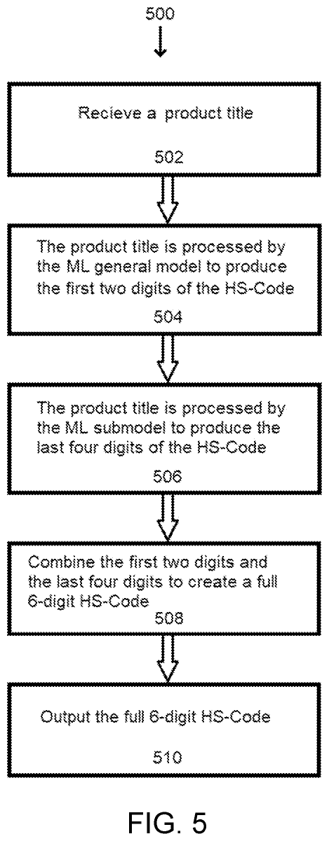

FIG. 5 is flowchart of the steps of a second method 500 of determining the HS-Code of a product, according to one embodiment the present invention.

The method starts at block 502. A user inputs a product title into the HS-code determination system where the ML general model and the ML submodels of the system have been trained according to the training method of FIG. 4.

The method proceeds to block 504. The product titled is processed by the ML general model, where the ML model outputs the first two digits of the HS-Code.

The method proceeds to block 506. The product title is processed by the ML submodel corresponding to the first two digits of the HS-Code, where the ML submodel outputs the last four digits of the HS-Code.

The method proceeds to block 508. The system combines the first two digits of the HS-Code produced by the ML general model with the last four digits of the HS-Code produced by the ML submodel into a full 6-digit HS-Code.

The method proceeds to block 510. The system outputs the product's full 6-digit HS-Code based on the based the product title. This 6-Digit HS-Code can be entered into the custom's database to determine appropriate product taxes and whether or not the product poses a security risk.

I claim:

1. A computer-implemented method of training a machine learning general model to determine an HS-Code based on a product title, the method comprising:
receiving a set of product titles;
applying a term frequency operation and an inverse document frequency operation to each of the product titles to create a set of product terms;
manually assigning an HS-Code to each of the product terms to create a set of HS-Codes;
creating a training set comprising the set of product terms and the set of HS-Codes; and
training the machine learning general model with the training set using supervised learning, wherein the set of product terms is an input and the set of HS-Codes is a desired output.

2. The method of claim 1, wherein the machine learning general model is trained using a Support Vector Machine algorithm.

3. A system for identifying an HS-Code based on a product title, the system comprising:
an input device configured to receive the product title;
a processor;
memory;
a machine learning general model stored in the memory and executed in the processor, the model trained by:
receiving a set of product titles;
applying a term frequency operation and an inverse document frequency operation to each of the product titles to create a set of product terms;
manually assigning an HS-Code to each of the product terms to create a set of HS-Codes;
creating a training set comprising the set of product terms and the set of HS-Codes;
training the machine learning general model with the training set using supervised learning, wherein the set of product terms is an input and the set of HS-Codes is a desired output; and
an output device configured to display the HS-Code, wherein the HS-Code corresponds to the product title.

4. The method of claim 3, wherein the machine learning general model is trained using a Support Vector Machine algorithm.

5. A system for identifying an HS-Code based on a product title, the system comprising:
an input configured to receive the product title;
a processor;
memory;
a machine learning general model stored in the memory and executed in the processor, the general model trained by:
receiving a set of product titles;
applying a term frequency operation and an inverse document frequency operation to each of the product titles to create a set of product terms;
manually assigning an HS-Code to each of the product terms to create a set of HS-Codes;
creating a training set comprising the set of product terms and the set of HS-Codes;
training the machine learning general model with the training set using supervised learning, wherein the set of product terms is an input and the set of HS-Codes is a desired output; and
machine learning submodels stored in the memory and executed in the processor, the submodels trained by:
receiving a set of the product titles;
applying the term frequency operation and the inverse document frequency operation to each of the product titles to create the set of product terms;
manually assigning the HS-Code to each of the product terms to create the set of HS-Codes;
creating the training set comprising the set of product terms and the set of HS-Codes, the training set divided into a training subset for each chapter number, wherein each training subset contains a subset of product terms and a subset of HS-Codes;
training the machine learning submodels with the training subsets using supervised learning, wherein a subset of product terms is an input and a subset of HS-Codes is a desired output; and
an output device configured to display the HS-Code, wherein the HS-Code corresponds to the product title.

6. The method of claim 5, wherein the machine learning general model and the machine learning submodels are trained using a Support Vector Machine algorithm.
